(19) United States
(12) Patent Application Publication
(10) Pub. No.: US 2012/0101888 A1
(43) Pub. Date: Apr. 26, 2012

(54) SYSTEM AND METHOD FOR OBTAINING CONTENT RELATED TO AN ARTICLE OF COMMERCE

(75) Inventor: Leigh M. Rothschild, Sunny Isles Beach, FL (US)

(73) Assignee: Reagan Inventions, LLC, Sunny Isles Beach, FL (US)

(21) Appl. No.: 13/341,148

(22) Filed: Dec. 30, 2011

Related U.S. Application Data
(63) Continuation-in-part of application No. 11/479,366, filed on Jun. 30, 2006.

(51) Int. Cl. G06Q 30/06; G06Q 30/02

(52) U.S. Cl. 705/14.23; 705/26.61

(57) ABSTRACT

Systems and methods are provided for delivering content to a mobile device over a network. One method for delivering content comprises the steps of obtaining location information from a location tracking module of a mobile device and identifying, by the mobile device, an article of commerce. The method also includes transmitting the location information and identification of the article of commerce from the mobile device to a server. Steps by the server include identifying a retailer based on the location information and retrieving content related to the identified article of commerce, wherein the content is available from the identified retailer. The method then includes transmitting the content from the server to the mobile device.

### CROSS-REFERENCE TO RELATED APPLICATIONS

This application is a continuation-in-part of U.S. patent application Ser. No. 11/479,366 filed on Jun. 30, 2006, the entire contents of which are hereby incorporated by reference.

### BACKGROUND

1. Field

The present disclosure relates generally to systems and methods for identifying an article of commerce and downloading content related to the article of commerce to a mobile device, such as a mobile phone.

2. Description of the Related Art

Portable digital devices are now common. Examples include the various Windows™ Pocket PC devices which have an operating system created by Microsoft Corporation of Redmond, Wash. Other devices include various mobile phone devices including many that have built-in camera imaging devices. Still other portable digital devices include portable media players from Creative Media of Singapore, Samsung of South Korea, Archos, Inc. of Irvine, Calif. and Apple Computers, Inc. of Cupertino, Calif. Additionally, Sony of New York and Japan manufacture a portable game playing device called the Sony PSP™ (PlayStation Portable).

Increasingly, many of these portable media devices include a means of transmitting and receiving digital content. Various communications technologies are frequently built into these devices. Examples of portable communicating devices include mobile phones which employ GSM, CDMA, W-CDMA, and FOMA technology, among other standards, to send and receive data in addition to handling voice communications. Many of the portable media devices also include transmission capabilities including Wi-Fi (i.e., IEEE 802.11a, b, g and x, among others), Bluetooth™, infrared, etc. to allow the user to transmit and receive digital content. The Sony PSP™ device, by example, includes Wi-Fi (i.e., IEEE 802.11b) to transmit and receive digital data.

In this age of readily accessible information, a need exists for a system and method to allow a consumer to identify an article of commerce at a location (such as a retail store) and to immediately download content related to this article of commerce into the user's mobile device, e.g., a portable media player device or mobile phone.

### SUMMARY

Systems and methods are provided for delivering content related to an article of commerce from a server to a mobile device over a network. One embodiment of a method for delivering content comprises obtaining location information from a location tracking module of a mobile device and identifying an article of commerce. The method also includes transmitting the location information and identification of the article of commerce to a server. The server identifies a retailer based on the location information and retrieves content related to the identified article of commerce, where the retrieved content is available from the identified retailer. The server then transmits the content to the mobile device. According to some examples, the content may include coupons, information about special deals, or other information related to purchasing the article of commerce.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is front view of a mobile device according to an embodiment of the present disclosure;

FIG. 1B is a rear view of a mobile device of FIG. 1A;

FIG. 2 is a block diagram of various modules included in the mobile device illustrated in FIG. 1;

FIG. 3 illustrates a system for delivering content to a user;

FIG. 4 is a flow diagram illustrating a method for delivering content to a user according to a first embodiment of the present disclosure; and

FIGS. 5A and 5B are flow diagrams illustrating a method of a mobile device for obtaining content related to an article of commerce according to a second embodiment of the present disclosure;

FIG. 6 is a flow diagram illustrating a method of a server for providing content related to an article of commerce to a mobile device according to the second embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for delivering content to a user are provided. The system and method allow a user to identify an article of commerce at a location (such as a retail store) where the article of commerce is being sold and to immediately download content related to the article of commerce into the user's mobile device, portable media device, or cellular/mobile phone. This will provide the user with instant access to content for helping the user to make a decision about purchasing the article of commerce or for getting a reduction in price off of the total cost of the article of commerce. The content may include coupons, advertisements, catalog information, or other information related to the article of commerce. The systems and methods may enable the user to determine a reduced price of the article of commerce at the source (e.g., a retail store) and download coupons or discounts from Internet sources. Further, the user may select multiple articles of commerce to obtain content about a variety of products available from the retailer.

In operation of the systems and methods of the present disclosure, a user utilizes a mobile device, e.g., a mobile phone or smart phone, to identify the article of commerce. The mobile device obtains location information, which can be used to determine that the user is shopping at a specific retailer or is near multiple retailers. The user locates an article of commerce, which may include any purchasable product at any retail store. Several technological solutions are provided to allow the article to be identified by a user. For example, the user may use a scanning device or a device containing a charge-coupled device (CCD), such as a camera, to take or scan a picture of a barcode on the article of commerce. Alternatively, the user may use a device containing a user interface allowing user keyboard input where the user will input the name of the item into the portable device. Or the user may speak the name of the article of commerce into the portable device where the device contains voice recognition software, etc. In a further embodiment, the articles of commerce may contain Radio Frequency Identification (RFID) tags wherein these tags identify the article of commerce to a reader module on the mobile device. Furthermore, if the device contains a CCD device (e.g., a camera), the user can take a picture of the article of commerce, and using standard and existing computer processing power and software solutions, such as image recognition software, or optical character recognition software, the image or name of the article of commerce can be decoded and the identity of the article of commerce can be resolved.

Once the article of commerce is identified, the mobile device can use communications protocols including but not limited to Wi-Fi (a, b, c, d, n, x), cellular communications such as GSM, CDMA, FOMA, etc., infrared communications, cabled communications, Bluetooth™ communications, satellite communications, etc., to transmit this identification information to a remote server on the global computer network (GCN), e.g., the Internet. In some embodiments, the user may also transmit information identifying the user submitting the request. The server will then use standard computer processing power and standard data look-up software to see if it has information, e.g., content, on the article of commerce, particularly from a specific retailer where the user is shopping. The server will use standard communications protocols to transmit information back to the mobile device or portable digital device. The mobile device presents the content or parts of content related to the selected article of commerce to the user. The user may be informed of a reduced price of this article of commerce, any valid coupons associated with the article, advertisements of the article, discounts or special deals associated with the article, etc.

If the user wants to purchase the article of commerce, the user may use the user interface that is built into his or her mobile device, including but not limited to character input, voice input, etc. to print out coupons or ask for available deals related to the article of commerce while in the process of purchasing the article. The content may also be used to inform the user of the features of the article of commerce or other information related to the article before the actual purchasing process.

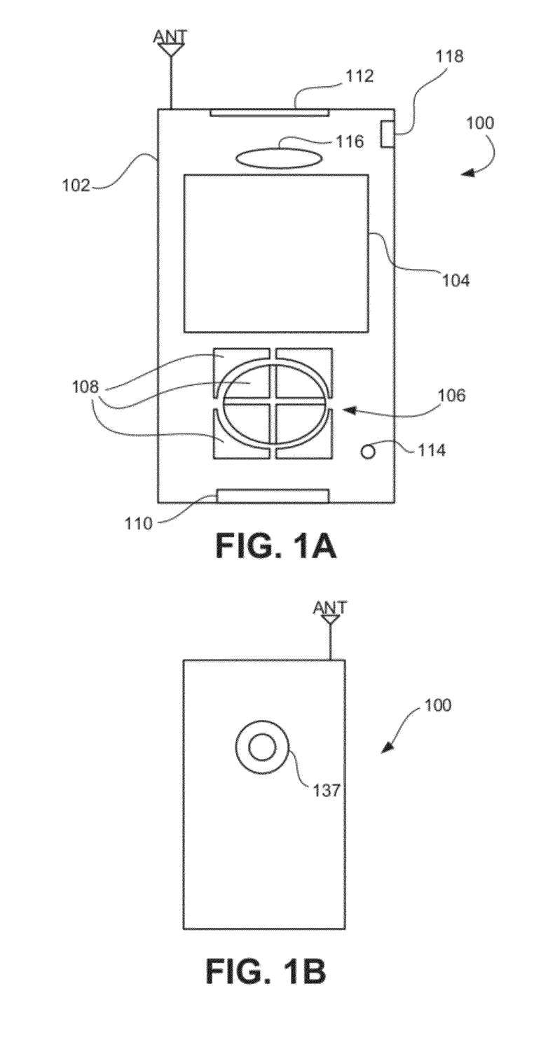

Referring to FIG. 1A, a mobile device 100 in accordance with an embodiment of the present disclosure is illustrated. The mobile device 100 may be a portable media playback device for receiving and playing various types of digital media content, e.g., audio, video, images, games, text, multimedia content, etc. The mobile device 100 includes various electrical components, which will be described in detail below and which may be disposed on or within a generally rectangular housing 102. A display module 104 is provided for displaying video and image media content, such as movies, animations, etc., and a speaker 116 is provided configured to produce audio, e.g., music or a soundtrack associated with a video. An audio port 118 will be configured to receive a plug or connector from a headphone, stereo system, etc. to stream the audio to the connected device. It is to be appreciated that when an external device is connected to the audio port 118, the speaker 116 may be disabled. Input module 106 includes a plurality of buttons 108 for inputting data and navigating through a plurality of menus. A touch screen overlaid upon the display module 104 may also be coupled to the input module 106 for facilitating user input. The mobile device 100 further includes a storage module 110 for storing a plurality of content and a transmission module 112 for transmitting/ receiving data and/or content via antenna ANT to another device, e.g., a personal computer, a personal digital assistant (PDA), a server residing on the Internet, etc. Optionally, the mobile device 100 may include a microphone 114 for acquiring input audio data from the user of the mobile device 100. Referring to FIG. 1B, when a user desires to capture an image, a lens 137 disposed on a rear side of the mobile device 100 is aimed at a subject of the image and may be used in conjunction with the display module 104 for positioning a subject of the image in lieu of a viewfinder.

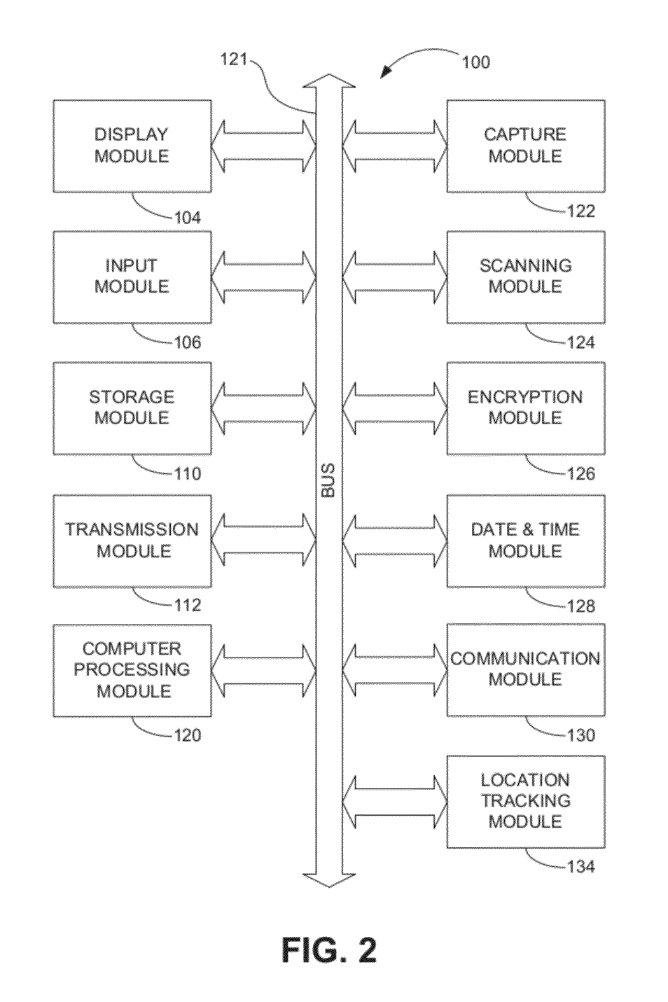

Referring to FIG. 2, the various electrical components of the device 100 will now be described. The device will contain a computer processing module 120, e.g., a microprocessor. The computer processing module 120 will use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The device also includes an operating system and micro instruction code preferably residing in read only memory (ROM) (not shown). The various processes and functions described herein may either be part of the micro instruction code or part of an application program (or a combination thereof) which is executed via the operating system. Exemplary operating systems include but are limited to SymbianOS, Windows Mobile/Windows CE, Palm OS, Linux, Blackberry OS, BREW, etc., which have been developed for mobile computing applications and can handle both data computing and communication applications, e.g., voice communications.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 120 may further include, in addition to a microprocessor, a digital signal processor (DSP) for decoding stored audio, video, and photo files to be played on the mobile device 100. As is known in the art, the DSP may include several known decompression algorithms for decompressing stored media content, e.g., a MP3 file. The mobile device 100 of the present disclosure may support various file types, including but not limited to Microsoft Windows Media Video files (.wmv), Microsoft Photo Story files (.asf), Microsoft Windows Media Audio files (.wma), MP3 audio files (.mp3), JPEG image files (.jpg, jpeg, .jpe, .jfif), MPEG movie files (.mpeg, mpg, .mpe, .m1v, .mp2v .mpeg2), Microsoft Recorded TV Show files (.dvr-ms), Microsoft Windows Video files (.avi), and Microsoft Windows Audio files (.wav).

The display module 104 may be configured for displaying digital information such as video files, image files, text files, etc. This display may be in any current form in the art, including Liquid Crystal Displays (LCD), Light Emitting Diode (LED) displays, Cathode Ray Tube (CRT) displays, or any other type of display currently existing or existing in the future. The display module 104 may also include an audio output device, e.g., a speaker 116, audio port 118, etc., allowing the user to also hear audio output from the device 100, e.g., audio associated with a video, a MP3 file, etc.

As shown in FIG. 2, the mobile device 100 of the present disclosure contains the input module 106 to either receive user instructions via text input by the way of buttons 108 (FIG. 1A), a standard keyboard interface coupled to the device, or a character recognition capture device which translates user text input into alphanumeric characters. Preferably, the character recognition device is a touch screen which overlays the display module 104 and text may be entered by pressure from the user's fingers or thumbs or via a pen-like stylus. Such input devices are standard and currently available on many electronic devices including portable digital assistants (PDAs), cellular telephones, etc. Optionally, microphone 114 may be further coupled to the input module 106 for capturing any audio information spoken by the user, in which case the input module 106 will further include an analog-to-digital (A/D) converter for converting the spoken audio information into a digital format. Furthermore, the input module 106 may include a voice recognition processor that translates the digital human voice into alphanumeric characters for user input. The user will utilize the input module 106 to enter various data, make selections, enter payment information, initiate communication with a remote server, manipulate content, etc.

The storage module 110 may include internal storage memory (e.g., random access memory (RAM)) or removable memory, such as magnetic storage memory. The storage module 110 may also include optical storage memory (e.g., various types of CD and DVD media), solid-state storage memory (e.g., a CompactFlash card, a Memory Stick, SmartMedia card, MultiMediaCard (MMC), SD (Secure Digital) memory), or any other memory storage that exists currently or will exist in the future.

The transmission module 112 will enable the mobile device 100 to transmit or transfer information to other computing devices and to receive information from other computing devices, e.g., digital media files, codes to unlock downloaded media, encryption/decryption keys, etc. The transmission module 112 will perform its functionality by hardwired and/or wireless connectivity. The hardwire connection may include but is not limited to hard wire cabling e.g., parallel or serial cables, USB cable, Firewire (1394 connectivity) cables, and the appropriate port. The wireless connection will operate under any of the various known wireless protocols, including but not limited to Bluetooth™ interconnectivity, infrared connectivity, radio transmission connectivity, including computer digital signal broadcasting and reception commonly referred to as Wi-Fi or 802.11x (where x denotes the type of transmission), satellite transmission or any other type of communication protocols or systems currently existing or to be developed for wirelessly transmitting data. The transmission module will compress and encode the encrypted information for transmission using any known wireless communication technology. In one embodiment, antenna ANT is coupled to the transmission module 112 for extending the wireless transmission range of the device 100. The antenna ANT may extend outside the housing 102 and/or may be incorporated inside the housing.

A capture module 122 is provided to capture an image desired by the user in digital form, e.g., an image of an article of commerce, a barcode, etc. The capture module 122 includes an image sensor, an analog-to-digital (A/D) converter and a digital signal processor (DSP). To capture an image, the user can aim the lens 137 disposed on the rear of the mobile device 100 at a subject. Light is allowed to enter through the lens 137 and shine on the image sensor, e.g., a charge-coupled device (CCD) or complimentary metal-oxide semiconductor (CMOS). The image sensor may include millions of photosensors, e.g., pixels, wherein each pixel absorbs the light and transforms the light into an electric charge proportional to the intensity of light. Each charge is transmitted to an A/D converter where the charge is converted into a digital value representing different intensities of red, green and blue, which designate the color for that pixel. The digital values are then passed to the digital signal processor which enhances the image, compresses it and then stores it in a digital file format in the storage module 110.

In other embodiments, the mobile device 100 will further include an integrated scanning module 124 for scanning symbology on an article of commerce. The scanning module 124 may contain a light source, e.g., LED, and photocell coupled to the computer processing module 120, or alternatively, may include a separate decoder engine that will decode the data received by the photocell before sending it to the computer processing module 120. Knowledge of the art reveals that many different types of scanners currently exist and the inventor realizes that the type of scanner would depend upon the type of symbology that is utilized. The symbology may be in any form currently practiced in the art including barcodes (e.g., UPC, EAN, PDF417, QR code format, TAG by MicroSoft code format, etc.), photosymbols, standard or specialized text, etc., or any future type of symbology.

It is to be appreciated that the capture module 122 may also be used in conjunction with the scanning module 124 to read symbology associated with an article of commerce. Here, the capture module 122 will acquire an image of the symbology and the scanning module 124 can further include a digital signal processor executing an algorithm for deciphering or decoding the symbology from the capture image 122. The use of an image sensor to read symbology, e.g., a barcode, is known in the art and systems employing such technology are commercially available, for example, from Symbol Technologies of New York.

The mobile device 100 also includes an encryption module 126. The encryption module 126 uses conventional code encryption algorithms currently in use or that will be in use in the future such as symmetric-key algorithms, e.g., DES, Triple-DES, Blowfish, RC2, RC4, RC5, etc, and asymmetric-key algorithms, e.g., Diffie-Hellman, RSA, ElGamal, etc. to decrypt locked digital media content files that are stored in the storage module 110. The encryption module 126 may also encrypt payment information of a user before the payment information is transmitted to another device or server.

Furthermore, the mobile device 100 may include a date and time module 128. The date and time module 128 will use standard computer chip processing technology widely in use, e.g., a crystal, or alternatively, input from a GPS receiver to supply the date and time. A location tracking module 134 is also provided for determining a location of the mobile device 100 or, more specifically, the location of a person using the mobile device 100. The location tracking module 134 may include a receiver and antenna employing conventional locational information processing technology such as Global Positioning Satellite (GPS) Technology, Loran Technology, or any other available locational technology, to indicate the exact location, e.g., latitude, longitude, and altitude, of the mobile device 100 at a time when the user wishes to obtain additional content of an article of commerce, such as when the user is shopping. The determined location may be indicative of the presence of a retail store or a location in proximity to one or more retail stores. Exemplary GPS receivers and antennas are described in U.S. Pat. Nos. 5,654,718 and 6,775,612, the contents of both of which are herein incorporated by reference. It is to be appreciated that the latitude, longitude, and altitude may be used to interact with maps stored in memory or in the storage module 110 of device 100 to determine the city, state or address of the location where the user is shopping. If the user roams during a time when the content of one or more articles of commerce is requested, the location tracking module 134 is able to continually update the location, such that information of the user's location can be used to determine when the user has left a retailer, entered a different retailer, or when the user is in the vicinity of multiple retailers, e.g., when the user is in a shopping mall.

In one embodiment, the device 100 according to the principles of the present disclosure is embodied as a mobile phone including the modules and architecture illustrated in FIG. 2. In this embodiment, microphone 106 is further coupled to a communication module 130 for encoding a user's speech to be transmitted via antenna ANT using CDMA, PCS, GSM or any other known wireless communication technology. The user will enter phone numbers to be dialed via the touch screen, or alternatively, as is known in the mobile phone art, the device 100 may include a full QWERTY keyboard as an input module to enter text information. In addition to producing audio from audio or multimedia content, speaker 116 will be coupled to the antenna ANT and a decoder for receiving and decoding voice communication from another mobile phone.

It is to be appreciated that the communication module 130 may include a single integrated circuit chip to perform data transfer and voice communications or a single module including a separate data transfer chip, e.g., a Wi-Fi transceiver, and a separate voice communication chip, e.g., a CDMA chip. In one embodiment, the communication module 130 will operate on the wireless GPRS (General Packet Radio Service) data protocol or a 3G protocol such as W-CDMA, CDMA2000 and TD-SCDMA. Both the GPRS and 3G protocols have the ability to carry both voice and data over the same service.

It is to be appreciated that the device 100 described above is an exemplary device and may include all or a portion of the modules described above. It is also to be appreciated that the components shown in FIG. 1A may have different shapes and relative sizes and may be arranged differently than shown. Furthermore, it is to be appreciated that existing mobile devices, e.g., mobile phones, digital media playback device, may be used in accordance with the principles of the system and method of the present disclosure described below.

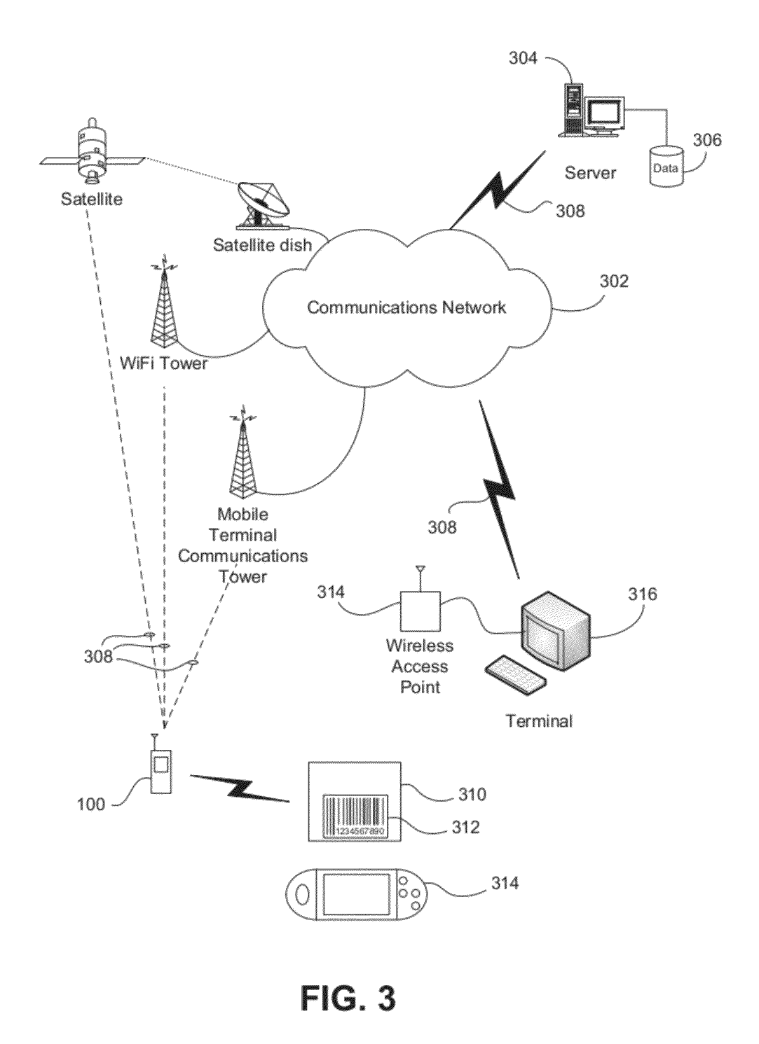

A system and method for identifying an article of commerce and delivering media content related to the article to a user over a network will be described in relation to FIG. 3. Referring to FIG. 3, a system in accordance with the present disclosure is illustrated. The system includes a mobile device 100 as described above. The device 100 may communicate to a server 304 via a communication network 302. The device 100 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 will communicate using the various known protocols such as Transmission Control Protocol/Internet Protocol (TCP/IP), File Transfer Protocol (FTP), Hypertext Transfer Protocol (HTTP), etc., and secure protocols such as Internet Protocol Security Protocol (IPSec), Point-to-Point Tunneling Protocol (PPTP), Secure Sockets Layer (SSL) Protocol, etc. The server 304 can further include a storage medium 306 for storing a database which links articles of commerce to content or information related to the articles, the details of which will be described in detail below.

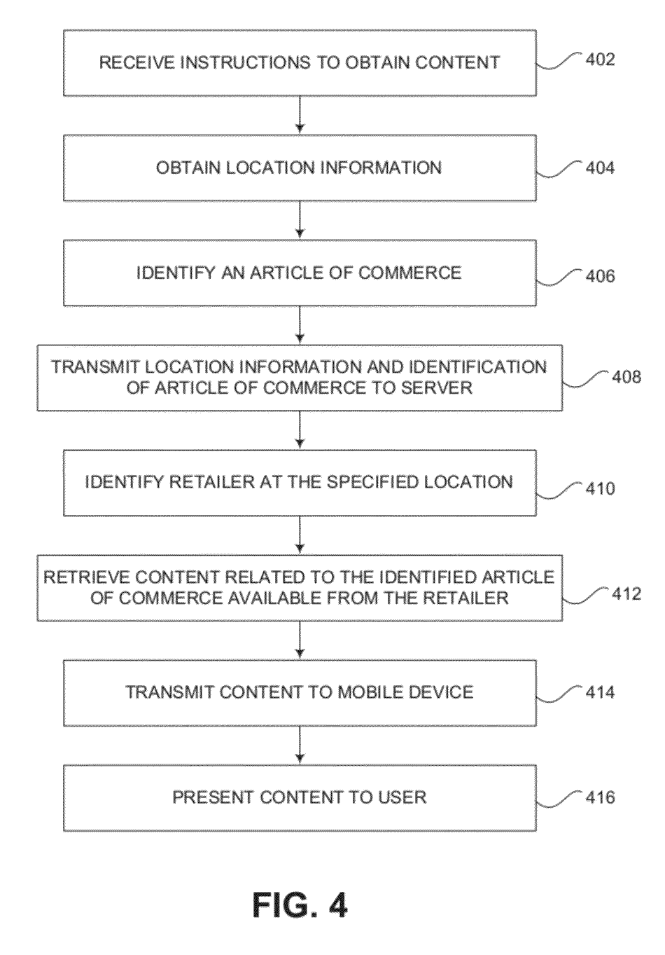

With respect to FIG. 4, a method is provided according to a first embodiment for enabling a user to download content related to an article of commerce of which the user may be interested in purchasing. In step 402, the user's mobile device (e.g., mobile device 100) receives an instruction from the user to obtain content. This step may involve receiving input from a user by any of the various user interfaces mentioned above. The appropriate input may initiate a program stored in memory for downloading content related to an article of commerce. The program may prompt the user to enter various data, such as location information or an identification of an article of commerce. The data input into the mobile device may be obtained manually from user input or obtained automatically from various modules (e.g., the location tracking module 134) on the mobile device 100, as mentioned below.

As indicated in block 404, the method includes obtaining location information. This information may be obtained, for example, using the location tracking module 134. Alternatively, the location may be obtained by the communication module 130, which may be configured to search for Wi-Fi signals to ascertain available networks in the vicinity. For instance, if a retailer offers Wi-Fi, then it can be determined from the communication module 130 when the user is within communication range of the retailer's Wi-Fi communication network. According to other means for obtaining location information, the user may simply enter information by typing the name of a retailer and the corresponding city onto a keypad, speaking the name and city into the microphone 110, or by other input methods as mentioned above.

In step 406, the method includes identifying an article of commerce. For example, the user may use the scanning module 124 to scan a bar code or other symbology of the article of commerce. Alternatively, the user may capture an image of the article of commerce using the capture module 122, wherein the capture module 122 may further be configured to use a visual search technique to determine the identity of the product from the capture image of the product. The article of commerce may also be identified by any identification code using the mobile device 100. As will be appreciated from the description below, the identification code may take many forms such as a barcode number, a UPC number, an alphanumeric number assigned to the article of commerce, an RFID transmission of the article, a name of the article, etc. The present disclosure may use any one or any combination of identification codes to determine if related content is available, for example, if a user identifies the article by name, the name may be used in a search engine to determine an associated alphanumeric code which will then be used to locate a record to determine if any related content is available for the identified article.

Then, according to block 408, the mobile device is configured to transmit the location information and the identification of the article of commerce to a server (e.g., server 304).

As indicated in block 410, the server, having received the location information and identification of the article of commerce, identifies the retailer that is operating at the specified location. This step may not be necessary if the user manually enters the specific information for properly identifying the retailer and the location information is not needed. Regarding step 410, the identification of the retailer may be determined automatically by the mobile device and server by the mobile device obtaining location information and transmitting this information to the server and by the server analyzing the location information to determine the identity of a retailer where the user is shopping.

In step 412, the method includes retrieving content related to the identified article of commerce available from the retailer. The content may be retrieved from various sources associated with the particular retailer, such as the retailer's website, product information stored in the database 306, or other sources. In step 414, the server is configured to transmit the content to the mobile device. When the mobile device receives the content, step 416 indicates that the content is presented to the user.

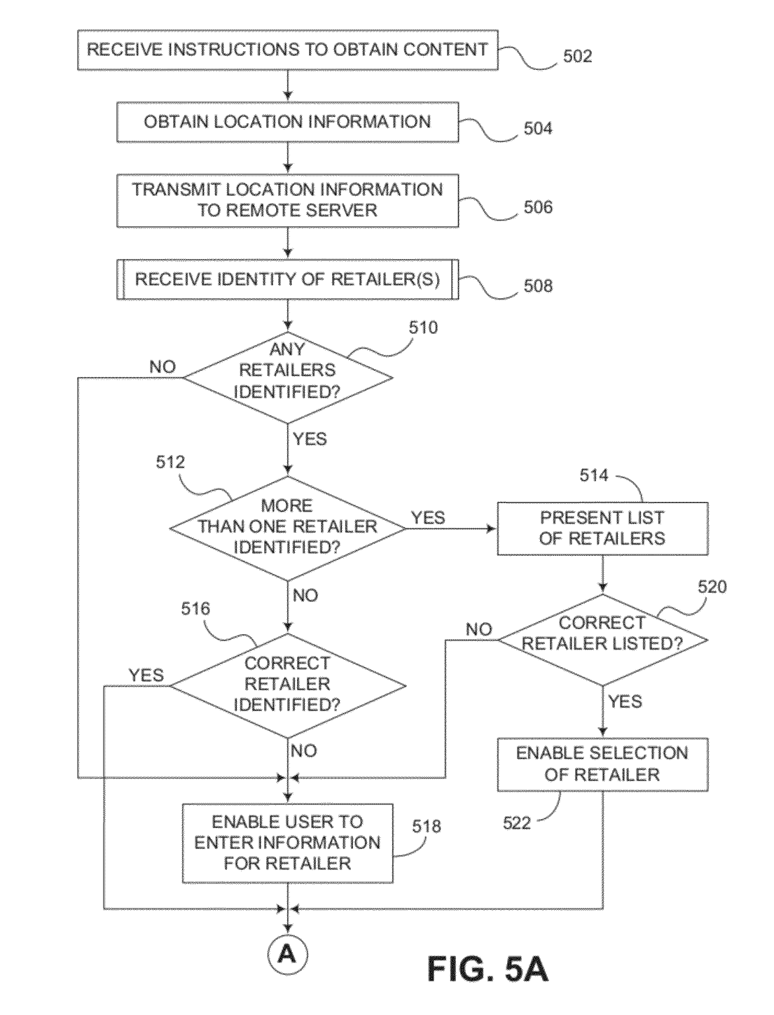

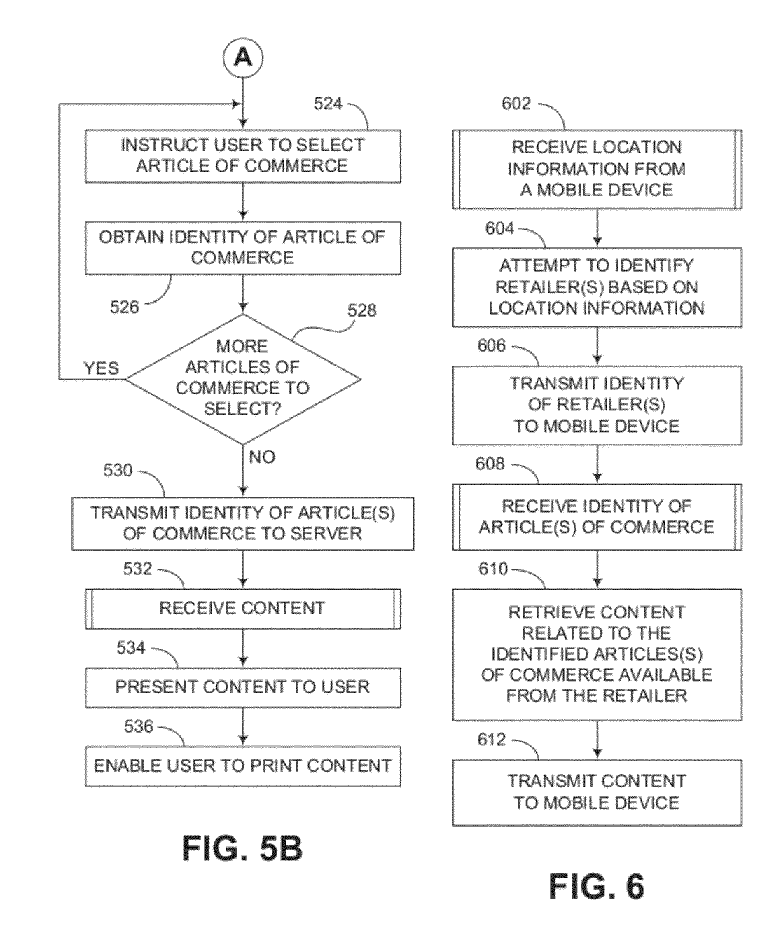

FIGS. 5A, 5B, and 6 are flow diagrams illustrating a method, according to a second embodiment, for obtaining content related to one or more articles of commerce. FIGS. 5A and 5B represent the steps of a mobile device that may be transported along with a user and FIG. 6 represents the steps of a server that communicates with the mobile device. Together the mobile device and server form parts of a system (e.g., the system shown in FIG. 3) for allowing a user to identify articles of commerce and then download information or content about the articles of commerce from the server that may help with the purchase of the articles of commerce. Particularly, the content related to the articles of commerce can be defined as the information about products or merchandise available to customer of an identified retail store, where the user is shopping. For example, the content may include coupons associated with the article, special deals associated with the article, product rebates, catalog information about the article, brochure information about the article, pricing information, advertisements, video, audio, text, web links, or other types of information about the article of commerce.

Furthermore, the method described with respect to FIGS. 5A, 5B, and 6 represent a method where a plurality of possible retailers may be identified. For example, if a user is shopping at a mall where several retailers are located within a small area, the user may need to select a retailer from a list of multiple retailers in the vicinity. Also, the embodiment of FIGS. 5A, 5B, and 6 allows a user to select any number of articles of commerce, if desired.

In step 502 of FIG. 5A, the method includes receiving instructions from a user to obtain content. This step may include an initiation of a content downloading application on a mobile device (e.g., mobile device 100), mobile phone, smart phone, laptop computer, tablet computer (e.g., an iPad™), or other portable device. In some applications, a user's mobile device may communicate with a computer, such as a desktop computer or laptop computer, which is associated with a communication system of a retailer.

Once the content downloading application has begun, the method proceeds to step 504, which indicates that the location information is obtained. The location information represents a location of the user when the user is carrying the mobile device with him or her. The location information may be obtained using a location tracking module of the mobile device, or in other embodiments, may be obtained by analyzing the available Wi-Fi networks within communication range of the mobile device. Blocks 502 and 504 may include the same steps as indicated with respect to block 402 and 404, respectively.

Block 506 indicates that the location information is transmitted from the mobile device to a remote server. In this embodiment, any conflict with the identity of a retailer can be resolved first before the user begins identifying one or more articles of commerce. The process of the mobile device must then wait for a response from the server before proceeding. After transmitting the location information (step 506), the server at this time receives the location information, as indicated with respect to step 602 in FIG. 6. As indicated in block 508, the mobile device receives the identity of the retailer or retailers from the server, which actually follows step 606 of FIG. 6 in time. Blocks in FIGS. 5A, 5B, and 6 illustrated with double lines on their sides, such as block 508, indicate a step in which waiting is involved. Therefore, in block 508, the mobile device waits to receive the retailer identity from the server after transmitting the location information.

Decision block 510 indicates that the method includes determining whether any retailers were identified. If not, the method skips ahead to block 518. If retailers were identified, the method proceeds to decision block 512, which determines is more than one retailer was identified. If more than one retailer is identified, the method goes to block 514. Otherwise, if only one retailer is identified, then the method goes to decision block 516. In decision block 516, it is determined whether the correct retailer has been identified, which involves confirmation from the user. If the correct retailer is confirmed, the method proceeds on to FIG. 5B. If the correct retailer has not been identified in decision block 516, then the method goes to block 518. In block 518, the method comprises enabling the user to enter information into the mobile device about the correct retailer. The information needed to properly identify a retailer is the retailer's name and the location (e.g., city and state) of the retailer.

If it is determined in block 512 that more than one retailer has been identified, then block 514 is executed, wherein the list of multiple retailers is presented for the user's selection. As indicated in decision block 520, it is determined whether or not the correct retailer is listed, which may involve an input from the user. For example, if not listed, the user may enter an input (e.g., pressing a “Not Listed” button) to indicate that the correct retailer is not listed. If not listed, the method proceeds to block 518 allowing the user to enter the information for the retailer. Entering the information may include using a keypad, keyboard, or other textual input means, or by speaking the retailer information in the microphone. If it is determined in block 520 that the correct retailer is listed, the method proceeds to block 522, enabling the selection of the retailer. The selection of the retailer may also be completed by the user. For example, a list may be presented on the mobile device and the user may be given an option to select a retailer by pressing the name of the retailer, entering a number associated with the retailer, or other selection means. In some embodiments, blocks 520 and 522 may include a single list allowing a user to select a retailer or indicate that the correct retailer is not listed. After the correct retailer has been selected (from any of blocks 516, 518, or 522), the method proceeds to FIG. 5B.

In FIG. 5B, after the retailer has been identified, the method goes to block 524, where the user is instructed to select an article of commerce. As indicated in block 526, the identity of an article of commerce is obtained. For example, the identity may be obtained by scanning (e.g., using scanning module 124) or capturing an image (e.g., using capture module 122) of symbology (e.g., a barcode) on the article of commerce. In other embodiments, the identity of the article of commerce may be obtained by capturing an image of the article and using a visual search technique, by entering the name of the article using a keypad, or by other techniques. According to decision block 528, the method asks the user whether or not more articles of commerce are to be selected. If the user answers affirmatively, the method loops back to block 524. Otherwise, the method proceeds to block 530.

As indicated in block 530, the method comprises transmitting the identity of the article(s) of commerce to the server (at which point the server receives the identities, corresponding to block 608 of FIG. 6). In block 532, the method of the mobile device waits to receive content from the server (corresponding to block 612). The received content is then presented to the user (step 534), such as by displaying the content on a display screen of the mobile device. Block 534 may include the same steps as block 416 of FIG. 4. As indicated in block 536, according to one embodiment, the method may enable the user to print the content. For example, the user may wish to print out coupons for one or more of the selected articles of commerce, wherein the coupons can be used to reduce the cost while purchasing the articles of commerce.

FIG. 6 is directed to an embodiment of a method performed by a server, or a group of servers, in communication with the mobile device described with respect to the steps executed in FIGS. 5A and 5B. In block 602, the server waits to receive location information from a mobile device (following the transmission step 506 of FIG. 5A). When the server receives the location information, the method includes attempting to identify one or more retailers based on the location information. The server may use GPS information, maps, or other locational information for determining a retailer or nearby retailers located at or near the location information related to the position of the user. As indicated in block 606, the method includes transmitting the identity of the retailer(s) to the mobile device.

After transmitting the retailer information and waiting for the user to select one or more articles of commerce, the method of FIG. 6 eventually receives the identity of the article(s) of commerce (step 608) from the mobile device. In addition, this step may also include receiving a selected retailer or a confirmation of a correct retailer, if necessary. For example, if multiple retailers were listed, the selected retailer is also communicated from the mobile device to the server, thereby indicating the actual retailer where the user is shopping. As indicated in block 610, the method comprises retrieving content related to the identified article(s) of commerce available from the retailer. For example, the server may be configured to retrieve coupons, special deals, advertisements, catalog information, brochure information, video, audio, text, web links, or other information related to the articles of commerce that the user may be interested in purchasing. This information may be retrieved from other servers and/or databases related to the selected retailer(s). Block 610 may include the steps indicated with respect to block 412. In step 612, the method includes transmitting the content to the mobile device (corresponding to step 532).

As an example of retrieving content (steps 412 and 610), if it is determined that the user is shopping in an electronics store (e.g., Best Buy) in a specific location (Concord Mills Mall in Concord, N.C.), the server may be able to retrieve special deals that are only available to customers at that particular store. For instance, if this store is overstocked with Toshiba laptop computers and the user shopping at this store expresses interested in purchasing a specific Toshiba laptop computer, then the server may be able to retrieve information regarding coupons, special deals, or advertisements about this product that are available only to customers at that particular store or that particular retailer.

According to some embodiments, the user may utilize the mobile device 100 to identify the article of commerce. For example, if the article of commerce 310 includes a barcode 312, the mobile device 100 can scan the barcode 312 with the scanning module 124 and decode the barcode to acquire an identification code of the article. Alternatively, the mobile device 100 can capture an image of the barcode using the capture module 122 and decode the barcode to acquire an identification code of the article. Furthermore, the user can also take a picture of the article of commerce via the capture module 122. Then, using standard and existing computer processing power and software solutions, such as Attrasoft Image recognition software, or optical character recognition software (OCR software such as OmniPage or ReadIris), the image or name of the article of commerce can be decoded and the identity of the article of commerce can be resolved. The user may also enter the identification code of the article or the name of the article via a user interface including input module 106. The user may also speak the name of the article of commerce into the portable device via the microphone 114, which in turn processes the spoken name into digital form via speech recognition software.

The article of commerce may also be identified without direct user intervention. For instance, when the articles of commerce may contain Radio Frequency Identification (RFID) tags. In this embodiment, the mobile device 100 contains an RFID reader and the identity of the article of commerce can be resolved by decoding the tags. In another embodiment, the name or identification code of at least one article of commerce will be broadcast via a Wi-Fi wireless access point 314 (FIG. 3) over a predetermined range. The mobile device 100 may be configured to receive this transmission via transmission module 112 and present a listing of the articles of commerce to the user via the display module 104. The user may then select an product of interest. An example of this embodiment would be in a retail store where a list of products is continuously broadcast in the store via a wireless access point 314 coupled to a server or terminal 316 in the store. This list might only be available when the user is within the confines of the store. The mobile device 100 presents this list to the user and the user may select a product of interest, wherein the identification code for the product would be identified via the terminal 316.

Once the article of commerce is identified, the mobile device 100 will use any communication protocol, including but not limited to Wi-Fi (a, b, c d, n, x), mobile phone communications such as GSM, CDMA, FOMA, etc., infrared communications, cabled communications, Bluetooth communications, satellite communications, or other protocol, to transmit the identification code to a remote server (e.g., server 304) on the global computer network (GCN), e.g., the Internet (step 530). It is to be appreciated that the mobile device 100 may use any one or a combination of protocols to transmit the identification code to the server 304. For example, the device 100 may employ a telecommunication protocol to transmit the identification code via the communication module 140. In another embodiment, the device 100 may communicate to the server 304 via the same wireless access point 314 that broadcast the list of available content, e.g., a hot spot in a retail location.

The server 304 may be maintained by a vendor associated with the article of commerce. For example, in the case of identifying a Warner Brothers DVD movie, the server may be a Warner Brothers server connected to a Warner Brothers website. However, the server may also be a vendor not associated or even competing with vendor of the article of commerce. For example, if the article of commerce is a Warner Brothers DVD movie, the server may be a retailer such as Best Buy that offers DVD movies from many companies, including not only Warner Brothers but also other companies such as Paramount, 20^{th} Century Fox, Walt Disney, Touchtone, Columbia, Universal, and others.

The server 304 may use standard computer processing power and standard database look up software (e.g., Microsoft™ Access or Oracles™ Database software) to see if it has information on the article of commerce in its database 306. Such information will include but not be limited to what the article of commerce contains.

The server 304 may use standard communications protocols described above to transmit or download the content or information to the mobile device 100. This information may appear on the display of the mobile device, although in another embodiment, this information may be provided to the user by audio via speaker 116 by utilizing a text-to-speech software program. The user will then be informed, i.e., by the server, what content related to the selected article of commerce is available.

Once the content is transmitted to the mobile device, the content may be stored in memory (e.g., stored in storage module 110). The content may be stored indefinitely or until the user selects another article of commerce or another set of articles. The user may recall this content from memory at any time.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for delivering content to a mobile device over a network, the method comprising the steps of:
obtaining location information from a location tracking module of a mobile device;
identifying, by the mobile device, an article of commerce;
transmitting the location information and identification of the article of commerce from the mobile device to a server;
identifying, by the server, a retailer based on the location information;
retrieving, by the server, content related to the identified article of commerce, the content being available from the identified retailer; and
transmitting the content from the server to the mobile device.

2. The method of claim 1, further comprising the step of presenting the content to a user of the mobile device.

3. The method of claim 1, wherein the content is at least one of an advertisement, catalog information, brochure information, and web link related to the article of commerce.

4. The method of claim 1, wherein the content is at least one of a coupon, discount, rebate offering, and special deal usable when purchasing the article of commerce.

5. The method of claim 4, further comprising the step of enabling a user of the mobile device to print the content.

6. The method of claim 1, wherein identifying the retailer based on the location information further comprising identifying a plurality of retailers based on the location information.

7. The method of claim 6, further comprising the steps of:
transmitting an identity of the plurality of retailers from the server to the mobile device;
presenting a list of the plurality of retailers to a user of the mobile device; and
enabling the user to select one of the retailers at which the user is shopping.

8. The method of claim 1, wherein if the step of identifying a retailer is unsuccessful, the method comprises the step of enabling a user of the mobile device to enter information regarding the identity of the retailer at which the user is shopping.

9. The method of claim 1, wherein:
identifying the article of commerce comprises identifying a plurality of articles of commerce;
transmitting the identification of the article of commerce comprises transmitting the identification of the plurality of articles of commerce from the mobile device to a server; and
retrieving the content comprises retrieving content related to the plurality of identified articles of commerce.

10. The method as in claim 1, wherein identifying the article of commerce comprises scanning symbology associated with the article of commerce to obtain an identification code.

11. The method as in claim 1, wherein identifying the article of commerce further comprising the steps of:
broadcasting at least one identification code of at least one article of commerce from a wireless access point over a predetermined range;
receiving, by the mobile device, the at least one identification code; and
enabling a user of the mobile device to select one of the at least one identification code associated with an article of commerce of interest to the user.

12. The method of claim 1, wherein the mobile device is a portable media player device or mobile phone.

13. A system for delivering content to a mobile device, the system comprising:
a mobile device comprising a location tracking module configured to obtain location information, the mobile device further comprising a module configured to identify an article of commerce, and the mobile device further comprising a transmission module configured to transmit the location information and identification of the article of commerce; and
a server configured to receive the location information and identification of the article of commerce, identify a retailer based on the location information, retrieve content related to the identified article of commerce from the identified retailer, and transmit the content to the mobile device.

14. The system of claim 13, wherein the mobile device further comprises a display module configured to present the content to a user.

15. The system of claim 13, wherein the content is at least one of an advertisement, catalog information, brochure information, and web link related to the article of commerce.

16. The system of claim 13, wherein the content is at least one of a coupon, discount, rebate offering, and special deal usable when purchasing the article of commerce.

17. The system of claim 16, wherein the mobile device further comprises a communication module configured to communicate the content to a printer for printing the content.

18. The system of claim 13, wherein the server is further configured to identify a plurality of retailers based on the location information and transmit an identity of the plurality of retailers to the mobile device

19. The system of claim 18, wherein the mobile device further comprises a display module configured to present a list of the plurality of retailers and an input module configured to enable the user to select one of the retailers at which the user is shopping.

20. The system of claim 13, wherein the mobile device comprises an input module configured to enable a user to enter information regarding the identity of the retailer at which the user is shopping if the server is unable to correctly identify the retailer.

21. The system of claim 13, wherein:
the module configured to identify the article of commerce is further configured to identify a plurality of articles of commerce;
the transmission module is further configured to transmit the identification of the plurality of articles of commerce to the server; and
the server is further configured to retrieve content related to the plurality of identified articles of commerce.

22. The system of claim 13, wherein the module configured to identify the article of commerce comprises a scanning module configured to scan symbology associated with the article of commerce to obtain an identification code.

23. The system of claim 13, wherein the module configured to identify the article of commerce comprises a capture module configured to capture an image of the article of commerce and identify the article of commerce based on visual recognition software.

24. A mobile device comprising:
a location tracking module configured to obtain location information indicative of the location of the mobile device;
a module configured to identify an article of commerce;
a transmission module configured to transmit the location information and identification of the article of commerce to a server, the transmission module further configured to receive, from the server, content related to the identified article of commerce available at a retailer identified based on the location information; and
a display module configured to present the content to a user.

25. The mobile device of claim 24, wherein the content includes at least one of an advertisement, catalog information, brochure information, and web link related to the article of commerce.

26. The mobile device of claim 24, wherein the content includes at least one of a coupon, discount, and special deal usable when purchasing the article of commerce.

27. The mobile device of claim 26, further comprises a communication module configured to communicate the content to a printer for printing the content.

28. The mobile device of claim 26, wherein the display module is further configured to present a list of a plurality of retailers identified by the server based on the location information.

29. The mobile device of claim 28, further comprising an input module configured to enable the user to select one of the retailers at which the user is shopping.

30. The mobile device of claim 24, further comprising an input module configured to enable a user to enter information regarding the identity of the retailer at which the user is shopping if the server is unable to correctly identify the retailer.

31. The mobile device of claim 24, wherein the module configured to identify the article of commerce is further configured to identify a plurality of articles of commerce.

32. The mobile device of claim 24, wherein the module configured to identify the article of commerce comprises a scanning module configured to scan symbology associated with the article of commerce to obtain an identification code.

33. The mobile device of claim 24, wherein the module configured to identify the article of commerce comprises a capture module configured to capture an image of the article of commerce and identify the article of commerce based on visual recognition software.
